(19) United States
(12) Patent Application Publication
(10) Pub. No.: US 2016/0205291 A1
(43) Pub. Date: Jul. 14, 2016

(54) System and Method for Minimizing Motion Artifacts During the Fusion of an Image Bracket Based On Preview Frame Analysis

(71) Applicant: PathPartner Technology Consulting Pvt. Ltd., Bangalore (IN)

(72) Inventors: Narasimha Kaushik Narahari, Bangalore (IN); Radhesh Bhat, Bangalore (IN); Tushar Adhikary, Bangalore (IN)

(73) Assignee: PathPartner Technology Consulting Pvt. Ltd., Bangalore (IN)

(21) Appl. No.: 14/991,795

(22) Filed: Jan. 8, 2016

(30) Foreign Application Priority Data
Jan. 9, 2015 (IN) 157/CHE/2015

(51) Int. Cl. H04N 5/21; G06T 5/50; H04N 5/235; H04N 5/14; H04N 5/232

(52) U.S. Cl. CPC H04N 5/211; H04N 5/144; H04N 5/23254; H04N 5/147; H04N 5/23267; H04N 5/2356; H04N 5/23293; G06T 5/50

(57) ABSTRACT

The present invention relates to system and method for minimizing motion artifacts during the fusion of an image bracket based on preview frame analysis. The system 100 mainly comprises a preview frame capture module 101 to render preview image frames typically invariant in exposure, focus and other related capture parameters at video rate. The system 100 also comprises a scene dynamic range assessment module 103 to assess the extent of dynamism of scene subjects and intensity expanse by sampling the scene at periodic intervals through preview image frames. The system 100 uses the calculated measure of dynamism and intensity distribution to control the parameters used for detecting and preventing motion artifacts during the fusion of subsequently captured bracket of images nuanced in capture parameters such as exposure or focus.

### TECHNICAL FIELD OF THE INVENTION

The present invention belongs to the field of handheld computational photography where multiple images are captured in sequence under nuanced capture conditions such as differing exposure, focus, etc., to generate a composite image with better visual information and reduced artifacts.

### BACKGROUND OF THE INVENTION

Existing computational photography techniques rely on capturing multiple images in succession to generate a resultant image which is the visual composite of the different features lucidly captured by each of them. For instance, High Dynamic Range (HDR) photography technique captures multiple images which differ in exposure times and fuses the clearly captured details in each of them into a single composite. Similarly, Extended Depth of Focus (EDOF) photography techniques capture images differing in focus and fuse the sections of the image captured sharply by each of them into a single composite. These are just a couple of examples from a plethora of image fusion techniques in computational photography.

Various types of conventional systems and methods to reduce motion artifacts in the images are in the prior art. The WO Patent document 2012173571 A1 describes a method and system for fusing images. The claimed invention relates to a method for fusing images, for example, first and second input images to form an output fused image. The input images are photographic images of the same scene captured successively and with different exposure times. The method comprises (i) transforming intensity values of at least one of the input images, to equalize the overall intensity of the input images; (ii) deriving, from values of at least one of the input images, locations of high frequency content portions of the output fused image; (iii) forming the high frequency content portions of the output fused image using spatial frequency domain chrominance and luminance values from the second input image; and (iv) forming other portions of the output fused image using spatial frequency domain chrominance values from the first input image and spatial frequency domain luminance values from the second input image.

The US Patent document 20130051644 A1 describes a method and apparatus for performing motion artifact reduction. The claimed invention relates to a method for reconstructing an image of an object having reduced motion artifacts includes reconstructing a set of initial images using acquired data, performing a thresholding operation on the set of initial images to generate a set of contrast images that identify areas of contrast from which motion artifacts originate, transforming the thresholded images into a conjugate domain, combining the conjugate domain representations of the contrast images, transforming the combined conjugate domain representations to an image domain to generate a residual image, and using the residual image to generate a final image of the object.

However, in claimed systems and methods the typical problem arises while adopting the existing image fusion techniques, due to the non-zero latency between the multiple images captured as the scene contents move resulting in artifacts in the fused image. This is because a scene subject, upon undergoing motion, appears with varying visual intensities at all the different positions of its path across captures in the final image. Such artifacts are termed as motion artifacts or ghost artifacts as there are moving objects while taking multiple images with different exposures.

Intensive research has been done to detect image pixel regions of the differently exposed images which contribute to motion artifacts and annul their effect in the final HDR photography image. For instance, Median Threshold Bitmap (MTB) techniques threshold the intensity components of the differing exposures about their medians to bring them to parity, and then exclude pixels which are not identical as in ‘Bitmap Movement Detection HDR for Dynamic Scenes’. Another technique used for detecting image pixel regions which contribute to motion artifacts includes measurement of local entropy of regions containing pixels of a moving subject.

However, the claimed system, method and existing techniques used for detecting and preventing motion artifacts operate on the captured image frames which differ in capture conditions such as exposure and focus, and are captured with perceptible latency. This is an ill-posed problem as the latency between capture of the different images in the bracket is a large multiple of that between successive frames of a video capture, thereby preventing the application of established and computationally inexpensive motion estimation techniques used in video, for the existing imaging techniques.

The above scenario may be well illustrated with the existing HDR technique in which the different capture exposure times results in images of differing brightness. Here, a static scene with no subject motion also cannot be established so certainly, as the captured images have to be brought to parity in intensity, for comparison. This factor also precludes use of simple motion estimation techniques used in video, which operate on a premise called the brightness constancy assumption.

All the existing techniques used for detecting and preventing motion artifacts attempt to overcome the above mentioned problems by using multiple probabilistic approaches. However, the existing techniques used for motion artifact detection/prevention fail to seize the opportunity of assessing scene dynamism based on available constant brightness, focus invariant, video-rate preview image frames prior to the actual capture; which is a major disadvantage especially in handheld cameras. This disadvantage is particularly emphasized in such handheld cameras because the limited computational resources and constrained time prevent iterations for perfectly identifying and avoiding the ghost pixels as enunciated by the current art.

Hence, there exists a need for a system and method for minimizing motion artifacts during the fusion of an image bracket based on preview frames analysis.

### SUMMARY OF THE INVENTION

The present invention overcomes the drawbacks in the prior art and provides a system and method for minimizing motion artifacts during the fusion of an image bracket based on preview frame analysis. The system comprises of a preview frame capture module, a scene dynamic range assessment module, a global motion isolation module, a deghost control module or a motion artifact control module and an image fusion module. The preview frame capture module is configured to capture and render one or more preview image frames at video rate to the user screen. The preview image frames are typically invariant in exposure, focus and other related capture parameters, wherein the preview image frames are rendered to the user screen when the camera application is triggered by the user. The global motion isolation module processes the successive preview frames and find the inter-frame misalignment due to user's clasp. The inter frame misalignment gives the global motion information between at least two frames. The scene dynamic range assessment module assesses the extent of dynamism of scene subjects after negating the inter frame misalignment estimated by global motion isolation module by grabbing the successive preview image frames from the preview frame capture module at predetermined intervals. The grabbed successive preview image frames are compared with each other to assess the motion dynamism of scene subjects, wherein the scene dynamic range assessment module classifies the grabbed successive preview image frames into one or more blocks of regular or structural dimensions. The scene dynamic range assessment module identifies and categorizes blocks at least as low motion, medium motion or high motion from the disparity values between block of regular or structural dimensions. The deghost control module or motion artifact control module detects the motion artifacts in the image bracket by using the processed blocks of regular or structural dimensions determined by the scene dynamic range assessment module. The image fusion module with help of the motion artifact control module fuse or merge the captured bracket of images after controlling the motion artifacts.

In a preferred embodiment of the invention, the global motion isolation module is further configured to find the global motion in the preview frames due to the user's clasp.

In a preferred embodiment of the invention, the scene dynamic range assessment module is further configured to compute the difference between the intensity component of the successive preview image frames at the level of blocks of regular or structural dimensions, after negating the effect of inter frame misalignment due to the unsteady clasp of the camera.

In a preferred embodiment of the invention, the system further compares the calculated disparity value between the successive preview image frames against multiple thresholds to categorize the extent of scene subject motion at-least as low motion, medium motion or high motion.

According to another embodiment of the invention, the invention provides method for minimizing motion artifacts during the fusion of an image bracket based on preview frame analysis. In most preferred embodiment, the method includes the step of capturing the successive preview image frames that are typically invariant in exposure and focus related capture parameters at video-rate. After capturing the successive preview image frames, the intensity components of the successive preview image frames are processed. The inter frame misalignment between the preview frames due to unsteady clasp of the camera is assessed. After processing the successive preview image frames, the grabbed successive preview image frames are classified into one or more blocks of regular or structural dimensions. The difference between the successive preview image frames at the blocks is computed, after negating the effect of inter frame disparity value due to global motion. After computing at each blocks, the disparity value between successive preview image frames are compared against the multiple thresholds to categorize the extent of scene subject motion at least as low motion, medium motion or high motion. The grabbed successive preview frames are again sampled after a time, wherein the time is predetermined intervals of the successive preview image frames. After sampling the grabbed successive preview frames, the region are classified and assessed for difference for motion in accordance with the exceeded preview difference threshold image frames. The threshold image frames are altered for identifying motion artifact pixels in accordance with the preview difference threshold image frames. After identifying region affected by motion artifacts, the motion artifacts in final fused image are compensated for example by masking motion artifact region pixels in image bracket.

The prior arts using the existing techniques for motion artifact detection or prevention fail to seize the opportunity of assessing scene dynamism based on available constant brightness, focus invariant, video-rate preview image frames prior to the actual capture.

The present invention has been designed to detect, minimize or avoid the motion artifacts during the fusion of an image bracket based on preview frame analysis.

The present invention provides a system and method which is simple, time saving, resource efficient, and cost effective. The invention may be implemented in any handheld camera environment.

It is to be understood that both the foregoing general description and the following details description are exemplary and explanatory and are intended to provide further explanation of the invention as claimed.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates a system for minimizing motion artifacts during the fusion of an image bracket based on preview frames analysis in accordance with one or more embodiment of the present invention.

FIG. 2 illustrates a method for minimizing motion artifacts during the fusion of an image bracket based on preview frames analysis in accordance with one embodiment of the present invention.

FIG. 2a illustrates a method for calculating the inter frame disparity value in accordance with one embodiment of the present invention.

FIG. 3 illustrates a method for minimizing motion artifacts in accordance with an alternate embodiment of the present invention.

### DETAILED DESCRIPTION OF THE INVENTION

Reference will now be made in detail to the description of the present subject matter, one or more examples of which are shown in figures. Each example is provided to explain the subject matter and not a limitation. Various changes and modifications obvious to one skilled in the art to which the invention pertains are deemed to be within the spirit, scope and contemplation of the invention.

The term ‘image bracket’ used herein refers to a general technique of taking several shots of the same subject using different camera settings so as to create a high dynamic range image.

The term ‘histogram’ used herein represents the lightness distribution in a digital image as discrete valued bins, often pictured graphically.

The present invention overcomes the drawback of prior art by providing a system and method that minimizes the motion artifacts during the fusion of an image bracket based on preview frames analysis. For this purpose, the system of the present invention samples preview image frames typically invariant in exposure, focus and other related capture parameters at video rate and assesses the extent of dynamism of scene subjects and intensity expanse. The system uses the calculated measure of dynamism and intensity distribution to control the parameters used for detecting and preventing motion artifacts during the fusion of subsequently captured bracket of images nuanced in capture parameters such as exposure or focus.

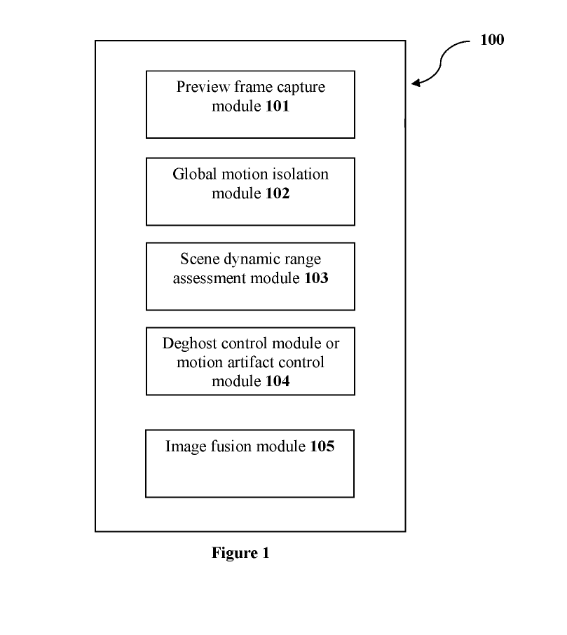

FIG. 1 illustrates a system for minimizing motion artifacts during the fusion of an image bracket based on preview frames analysis in accordance with one or more embodiment of the present invention. The system 100 of the present invention mainly comprises a preview frame capture module 101 to capture and render preview image frames usually of a smaller resolution than the actual capture to the user screen as preview, as prior to triggering a capture the available frames are typically invariant in exposure, focus and other related capture parameters. The system 100 of the present invention further comprises a global motion isolation module 102 to assess the global motion between successive preview frames due to unsteady clasp of the camera and a scene dynamic range assessment module 103 to assess the extent of dynamism of scene subjects and intensity expanse by sampling the scene at periodic intervals through preview frames and to analyze the scene radiance. The system 100 further comprises a deghost control module 104 or motion artifact control module to use the calculated measure of dynamism and intensity distribution for detecting and preventing or minimizing motion artifacts. The captured bracket of images nuanced in capture parameters such as exposure or focus is merged or fused by an image fusion module 105.

The system 100 of the present invention may be implemented in any handheld camera environment.

In accordance with one embodiment of the present invention, the preview frame capture module 101 is able to access the preview image frames at video-rate easily. The global motion isolation module 102 assess the inter frame misalignment between the successive preview frames due to user's unsteady clasp. The scene dynamic range assessment module 103 grabs successive preview image frames typically invariant in exposure, focus and related capture parameters by the preview frame capture module 101 at predetermined intervals; and compares the grabbed successive preview image frames with each other to assess subject dynamism of scene subjects. Here, the scene dynamic range assessment module 103 processes the intensity components of the successive preview image frames. The scene dynamic range assessment module 103 may be configured to compute the difference between the intensity component of the successive preview image frames at the level of blocks of regular or structural dimensions of interest after negating the effect of inter frame misalignment due to the unsteady clasp of the camera identified by the global motion isolation module 102.

In accordance with one or more embodiments of the present invention, the global motion isolation module 102 is configured to process the intensity component of the successive preview image frames and compute the disparity between the successive preview frames at the level of blocks of regular/structural dimensions of interest. The global motion isolation module 102 then computes the inter frame misalignment due to the unsteady clasp of the camera by user.

The scene dynamic range assessment module 103 compute the difference between the intensity component of the successive preview image frames at the level of blocks of regular or structural dimensions of interest and compares the calculated disparity value between the successive preview image frames against multiple thresholds to categorize the extent of scene subject motion as low motion, medium motion or high motion. Multiple thresholds are set to gauge the degree to which scene contents change across the captured successive preview frames. The scene dynamic range assessment module 103 further samples the scene again by grabbing successive preview frames after a time, wherein the time is predetermined intervals of the successive preview image frames. The scene dynamic range assessment module 103 then classifies the region assessed for difference, for motion in accordance with the exceeded preview difference threshold. Here, the deghost control module 104 or the motion artifact control module 104 is influenced based on which threshold has been exceeded. For instance, estimation of higher motion in preview would lead to correspondingly lower tolerance for inter-frame disparity during the identification of motion artifact pixels by the deghost control or motion artifact control module 104.

In accordance with one embodiment of the present invention, let us consider a scenario in which prior information related to the extent of scene dynamism is made available to any of the current techniques used for detecting and preventing motion artifacts on the captured image frames of differing exposures. For instance, let us consider the ‘Automatic high dynamic range image generation for dynamic scenes’ technique which rely on statistical measures of image entropy and variance to identify motion artifact pixels, the thresholds set to convert the uncertainty image to binary are merely heuristic and not robust. Let us consider that the information related to the extent of scene dynamism is made available to the ‘Automatic high dynamic range image generation for dynamic scenes’ technique, then the threshold used for turning difference image into binary is guided. The threshold may be decreased resulting in increased sensitivity to differences based on the extent of motion estimated by the scene dynamic range assessment module 103. The deghost control module 104 or motion artifact control module may control the thresholds or parameters such as size of the window for local entropy calculation, size of the window for morphological operations during the identification of motion artifacts and isolate it.

The system 100 of the present invention may be used to identify and isolate regions of constant motion in the scene. Hence, the region of the scene undergoing constant motion is turned to a binary valued cluster with a lesser threshold than a scene deemed rather static by the preview analysis. Also, it is essential to perform the task of mapping the high-motion clusters in the scene between the preview and captured image frames which are of different resolutions.

In accordance with an alternate embodiment of the present invention, the scene dynamic range assessment module 103 may also be configured to grab a single preview image frame so as to analyze the scene radiance. The scene dynamic range assessment module 103 processes the intensity component of the preview image frames captured in order to generate a histogram. The scene dynamic range assessment module 103 computes the concentration of the histogram at the higher intensity values so as to gauge the amount of light saturation/extent of very brightly illuminated regions in the preview image frame. Similarly concentration of the histogram at the lower intensity values is computed to gauge the extent of very dimly lit regions in the preview image frame. Histograms are also generated for successive preview image frames of a scene. The scene dynamic range assessment module 103 further creates an intensity mapping function between the successive preview image frames of a scene using a joint histogram so as to identify and sequester pixel regions. Here, the tolerance to ghosting in the motion artifact avoidance module 104 is altered based on the extent of intensity saturation and de-saturation identified by the scene dynamic range assessment module 103.

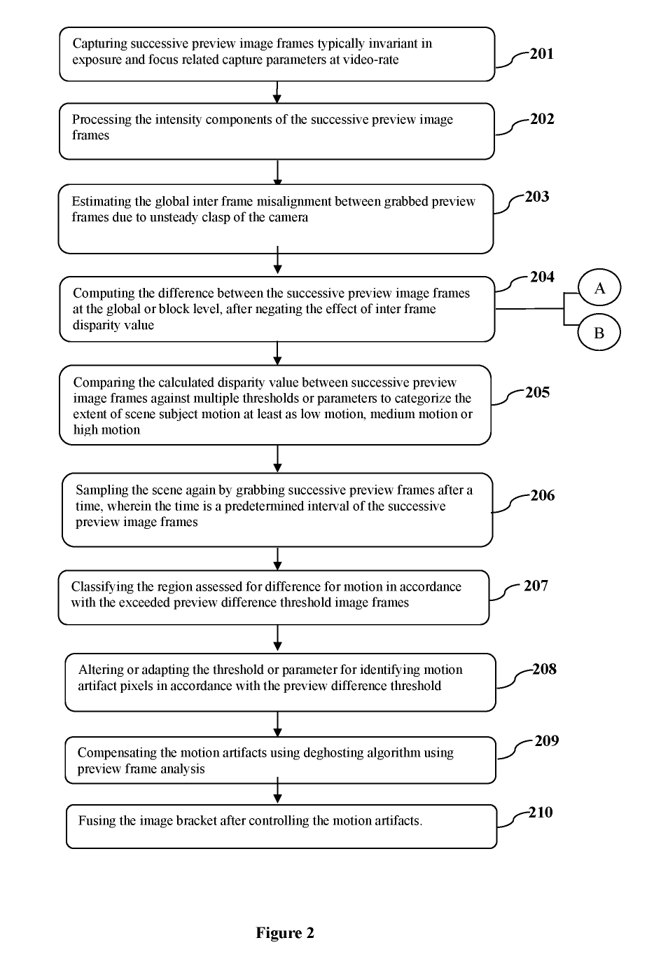

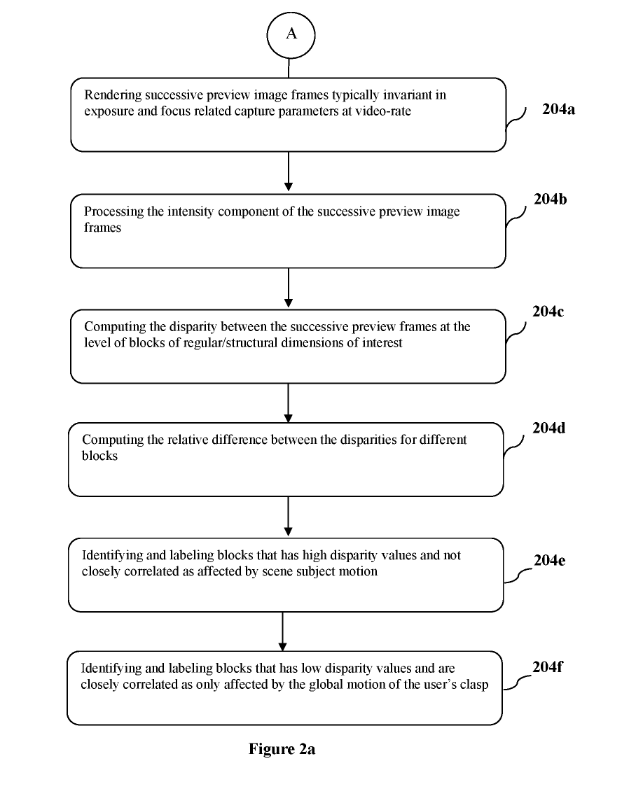

FIG. 2 illustrates a method for minimizing motion artifacts during the fusion of an image bracket based on preview frames analysis in accordance with one embodiment of the present invention. The method includes the step of capturing the successive preview image frames that are typically invariant in exposure and focus related capture parameters at video-rate in step 201. After capturing the successive preview image frames, at step 202, the intensity components of the successive preview image frames are processed. After processing the successive preview image frames, at step 203, the grabbed successive preview image frames are classified into one or more blocks of regular or structural dimensions. The inter frame misalignment due to unsteady clap of the camera by user is assessed. At step 204, the difference between the successive preview image frames at the level of blocks of regular/structural dimensions of interest is computed, after negating the effect of inter frame disparity value from step 203. After computing at each block, at step 205, the disparity value between successive preview image frames are compared against the multiple thresholds to categorize the extent of scene subject motion as low motion, medium motion or high motion by executing step 205. At step 206, the grabbed successive preview frames are again sampled after a time, wherein the time is predetermined intervals of the successive preview image frames. After sampling the grabbed successive preview frames, at step 207, the region are classified and assessed for difference for motion in accordance with the exceeded preview difference threshold image frames. At step 208, the threshold image frames are altered for identifying motion artifact pixels in accordance with the preview difference threshold image frames. After identifying the motion artifacts, at step 209, the motion artifacts in the successive preview image frames are controlled. Finally, at step 210, the bracket of captured images is fused after controlling the motion artifacts.

FIG. 2a illustrates a method for calculating the inter frame disparity value in accordance with one embodiment of the present invention. In step 204a the preview frames are grabbed from preview frame capture module and the inter frame misalignment due to unsteady clasp of camera is negated. In step 204b, processing the intensity component of the successive preview image frames and computing the disparity between the successive preview image frames at the level of blocks of regular/structural dimensions of interest in step 204c. Computing the relative difference between the disparities for different blocks in step 204d. In step 204e, identifying and labeling blocks that has high disparity values and not closely correlated as affected by scene subject motion. Similarly, identifying and labeling blocks that has low disparity values and are closely correlated as only affected by the global motion due to the user's unsteady clasp in step 204f.

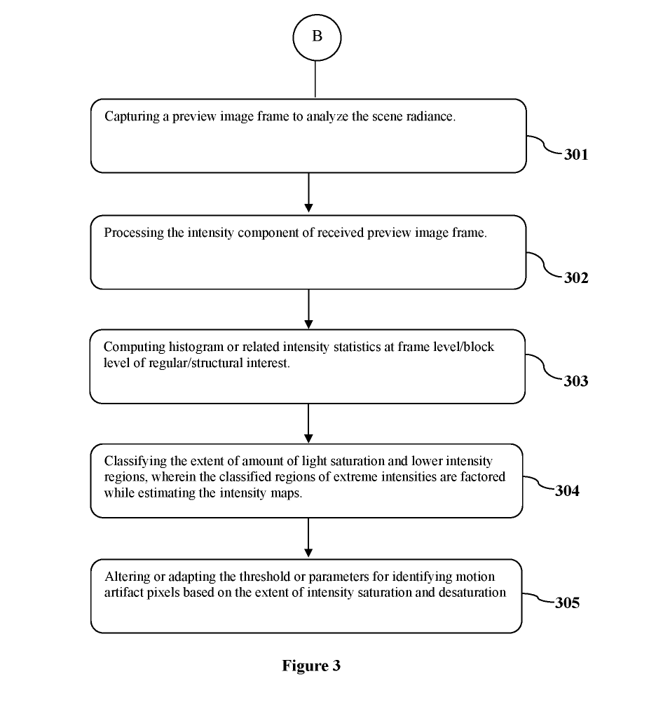

FIG. 3 illustrates a method for minimizing motion artifacts in accordance with an alternate embodiment of the present invention. A method for minimizing motion artifacts during the fusion of an image bracket based on preview frame image analysis comprises the steps of rendering a preview image frame to analyze the scene radiance in step 301. In step 302, processing the intensity component of received preview image frame. Computing histogram and other intensity statistics at frame level/block level of regular/structural interest in step 303. Classifying the extent of amount of light saturation and lower intensity regions, wherein the classified regions of extreme intensities are factored while estimating the intensity maps between images of different exposures in step 304. In step 305, altering the threshold for identifying motion artifact pixels based on the extent of intensity saturation and de-saturation.

Thus the system 100 and method of the present invention assesses scene dynamism based on the rendered successive preview image frames of a scene at video rate, typically invariant in exposure, focus and other related capture parameters. Also by using successive preview image frames for assessing scene dynamism, the system 100 allows the usage of simple motion estimation techniques for identifying motion artifacts in a hand-held camera environment.

The prior arts using the existing techniques for motion artifact detection or prevention fail to seize the opportunity of assessing scene dynamism based on available constant brightness, focus invariant, video-rate preview image frames prior to the actual capture.

The present invention has been designed to detect, minimize and avoid the motion artifacts during the fusion of an image bracket based on preview frame analysis.

The present invention provides a system and method which is simple, time saving, resource efficient, and cost effective. The invention may be implemented on any handheld camera environment.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

We claim:

1. A system for minimizing motion artifacts during the fusion of an image bracket based on preview frame analysis, the system comprises of:
a) a preview frame capture module 101 configured to capture one or more preview image frames at video rate and render to the user screen, wherein the preview image frames are typically invariant in exposure, focus and other related capture parameters, wherein the preview image frames are rendered to the user screen when the camera application is triggered;
b) a global motion isolation module 102 processes the blocks of regular or structural dimensions by computing the intensity component of the successive preview image frames and the disparity between the successive preview frames and computes the inter frame misalignment due to unsteady clasp of camera by user;
c) a scene dynamic range assessment module 103 assesses the extent of dynamism of scene subjects in the successive preview image frames from the preview frame capture module 101 at predetermined intervals, wherein the grabbed successive preview image frames are compared with each other to assess the subject dynamism of scene subjects after negating the inter frame misalignment between the frames.
d) a deghost control module or motion artifact control module 104 detects and isolates motion affected pixels in the image bracket based on the preview frame analysis which reduces the motion artifacts in the final fused image
e) an image fusion module 105 with help of the motion artifact control module 104 fuse or merge the bracket of images after controlling the motion artifacts.

2. The system as claimed in claim 1, wherein the global isolation module 102 assess the inter frame misalignment caused due to the unsteady clasp of the camera by user.

3. The system as claimed in claim 1, wherein the scene dynamic range assessment module 103 is further configured to compute the difference between intensity component of successive preview image frames at the level of blocks or regular interest after negating the inter frame misalignment calculated by global isolation module 102.

4. The system as claimed in claim 1, wherein the system 100 further compares the calculated disparity value between the successive preview image frames against multiple thresholds to categorize the extent of scene subject motion at-least as low motion, medium motion or high motion.

5. A method for minimizing motion artifacts during the fusion of an image bracket based on preview frame analysis, the method comprising the steps of:
a) capturing the successive preview image frames that are typically invariant in exposure and focus related capture parameters at video-rate 201;
b) processing the intensity components of the successive preview image frames 202;
c) estimating the global inter frame misalignment between grabbed preview frames due to unsteady clasp of the camera 203;
d) computing the difference between the successive preview image frames at the global or block level, after negating the effect of inter frame disparity value 204;
e) comparing the calculated disparity value between successive preview image frames against multiple thresholds or parameters to categorize the extent of scene subject motion at-least as low motion, medium motion or high motion 205;
f) sampling the scene again by grabbing successive preview frames after a time, wherein the time is predetermined intervals of the successive preview image frames 206;
g) classifying the region assessed for difference for motion in accordance with the exceeded preview difference threshold image frames 207;
h) altering or adapting the threshold or parameters for classifying motion artifact pixels in accordance with the preview difference threshold image frames 208;
i) compensating the motion artifacts utilizing preview frame analysis in deghosting algorithm 209; and
j) fusing the bracket of images after controlling the motion artifacts 210.

6. The method as claimed in claim 5, wherein the method further comprising the steps of:
a) capturing a preview image frame to analyse the scene radiance 301;
b) processing the intensity component of received preview image frame 302;
c) computing histogram or related intensity statistics at frame level/block level of regular/structural interest 303;
d) classifying the extent of amount of light saturation and lower intensity regions, wherein the classified regions of extreme intensities are factored while estimating the intensity maps 304; and
e) altering or adapting the threshold or parameters for identifying motion artifact pixels based on the extent of intensity saturation and de-saturation 305.
